(19) United States
(12) Patent Application Publication
(10) Pub. No.: US 2021/0197491 A1
(43) Pub. Date: Jul. 1, 2021

(54) HYBRID ADDITIVE AND SUBTRACTIVE MANUFACTURING SYSTEM AND METHODS OF OPERATION

(71) Applicant: Jonathan Worthy Hollander, Oakland, CA (US)

(72) Inventor: Jonathan Worthy Hollander, Oakland, CA (US)

(21) Appl. No.: 17/133,582

(22) Filed: Dec. 23, 2020

Related U.S. Application Data
(60) Provisional application No. 62/954,233, filed on Dec. 27, 2019.

(51) Int. Cl. B29C 64/393; B29C 64/118; B29C 64/209; B29C 64/236; B29C 64/232; B29C 64/188; B33Y 10/00; B33Y 50/02

(52) U.S. Cl. CPC B29C 64/393; B29C 64/118; B29C 64/209; B33Y 50/02; B29C 64/232; B29C 64/188; B33Y 10/00; B29C 64/236

(57) ABSTRACT

A manufacturing system and method combines additive material deposition at a coarse resolution with high speed subtractive material removal at part surfaces to maximize detail and dimensional accuracy. Additive and subtractive operations may be performed sequentially or in parallel. Model data is received and support model data for undercuts, overhangs, and constrained surfaces is generated. The model and support model data is partitioned into additive and subtractive layers. Additive toolpaths are generated for each of the additive layers and subtractive toolpaths are generated for each of the subtractive layers. The subtractive toolpaths from adjacent subtractive layers may be consolidated, and then scheduled using a spatial-temporal map to resolve dependencies on additive toolpaths. A hybrid manufacturing program including the additive and subtractive operations is output.

### CROSS-REFERENCE TO RELATED APPLICATIONS

This application claims priority to U.S. Provisional Patent Appl. No. 62/954,233, filed Dec. 27, 2019, titled “HYBRID ADDITIVE AND SUBTRACTIVE AUTOMATED MANUFACTURING SYSTEM,” which is incorporated by reference herein for all purposes.

### BACKGROUND OF THE INVENTION

The present invention relates to the field of automated manufacturing systems and methods of controlling the same. Automated manufacturing systems are capable of manufacturing parts with complicated geometry from a variety of materials. Automated manufacturing systems include subtractive manufacturing systems, which create parts by removing material, such as computer-numerical control (CNC) mills, and additive manufacturing systems, which create parts by depositing material, such as 3D printing.

Additive manufacturing offers the potential to create parts and assemblies of parts with geometric complexity, assembly complexity, material complexity, and customizability beyond the capabilities of legacy manufacturing processes. However, current additive manufacturing systems fall short in creating functional parts at prototyping and production volumes. Existing additive systems provide either high mechanical tolerances, high speed, or high-quality material properties, but nothing provides all three.

For example, stereolithography additive manufacturing processes can produce parts with excellent mechanical tolerances. However, the photosensitive resins used in these processes are often extremely expensive and their material properties are often deficient compared with commodity plastics. Moreover, these processes cannot produce parts or assemblies with multiple materials in the same part.

Similarly, powder-based additive manufacturing processes, such as binder jetting and selective laser sintering/melting, can utilize materials with excellent mechanical properties. However, these materials often have to be provided in expensive powder-based forms. Moreover, these processes cannot make parts or assemblies with multiple materials and provide mediocre mechanical tolerances compared with subtractive processes.

Fused filament fabrication can work with a variety of materials with excellent properties in relatively inexpensive filament or pellet formats and can support multiple materials in the same part. However, the mechanical tolerances of this process are very poor, often an order of magnitude worse than subtractive processes.

Furthermore, because additive manufacturing is a volumetric process, manufacturing time is proportional to the cube of the parts' linear dimensions. This exponential increase in manufacturing time makes many stereolithography, powder-based, and fused filament additive manufacturing processes slow and impractical to scale to large parts.

### BRIEF DESCRIPTION OF THE DRAWINGS

The invention will be described with reference to the drawings, in which:

FIG. 1 illustrates a block diagram of a hybrid additive and subtractive manufacturing system according an embodiment of the invention;

FIG. 2 illustrates a general method of operation for a hybrid additive and subtractive manufacturing system according to an embodiment of the invention;

FIGS. 3A-3E illustrate a hybrid additive and subtractive manufacturing process according to an embodiment of the invention;

FIGS. 4A-4F illustrate example manufacturing system architectures according to embodiments of the invention;

FIG. 5 illustrates an example method for converting design data into a manufacturing program for a hybrid additive and subtractive manufacturing system according to an embodiment of the invention;

FIG. 6 illustrates an example method for coordinating dependencies between additive and subtractive manufacturing processes according to embodiments of the invention; and

FIG. 7 illustrates a computer system suitable for controlling an automated manufacturing system according an embodiment of the invention.

### SUMMARY

Embodiments of the invention combine additive material deposition at a coarse resolution to maximize volumetric deposition speed with high speed subtractive material removal at part surfaces to maximize detail and dimensional accuracy. Embodiments of the invention may perform these additive and subtractive operations simultaneously to optimize manufacturing throughput.

Because additive manufacturing is a volumetric process, the additive processing time is proportional to the cube of the part's linear dimensions. However, the part surface area scales with only the square of the pads linear dimensions. If the volume of material removed in subtractive processing is relatively small as compared with the volume of material deposited in additive processing, then the subtractive processing time is approximately proportional with the part surface area. Therefore, subtractive processing at the part surface can be performed at a much faster rate than additive processing throughout the part volume with the same level of detail, even if these processing tools move at similar speeds. This allows sufficient time to perform subtractive processing in parallel with the additive processing.

### DETAILED DESCRIPTION

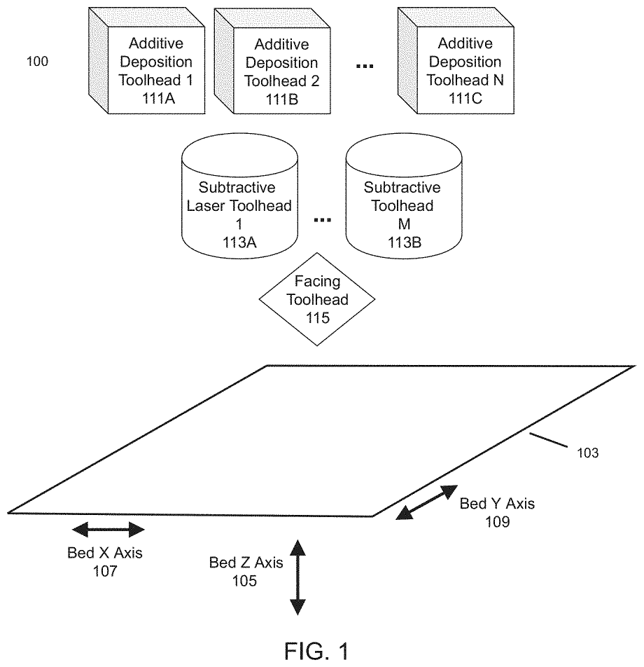

FIG. 1 illustrates a block diagram of a hybrid additive and subtractive manufacturing system according to an embodiment of the invention. System 100 includes N additive deposition toolheads 111, where N is one or more, such as toolheads 111a, 111b, and 111c. Each of the additive deposition toolheads is capable of depositing a structural or support material in a spatially-localized region, including a finite thickness in the Z dimension, referred to herein as an additive layer thickness.

Embodiments of additive toolheads include extruders for depositing plastic or other materials in liquid or semi-solid phase, which then solidify using thermal and/or chemical means. Additive extrusion toolheads may be supplied with material in filament, pellet, paste, or liquid form, and each material may be chemically complete prior to extrusion or provided in the form of one or more chemical precursors that react within the additive toolhead or after deposition to form a solid material.

In addition to extrusion-based additive toolheads, embodiments of the invention may include photopolymerization additive processes, such as stereolithography; material or binder jetting additive processes; powder fusion additive processes, such as selective laser sintering and melting and laser powder deposition; directed energy additive processes; lamination additive processes; welding-based additive processes, including laser, electrical, ultrasonic, and solid-state welding processes; or other additive systems based on selectively hardening, softening, curing, chemically reacting or inhibiting, removing, or depositing material in areas where energy is directed.

Additive toolheads may deposit materials including thermoplastic materials; thermoset materials; fiber-reinforced materials including chopped and/or continuous fibers; photosensitive structural materials including photopolymers; metals; ceramics; support materials that can be removed using mechanical force, water or other solvents, chemical reactions, heat or cold, light or other electromagnetic radiation, or the passage of time; and any other materials known in the art that can be additively manufactured. Materials may be in the form of solid rods or filaments, wires, foils, films, powders, powders mixed with liquid or solid binders, and gels.

In an embodiment, at least a portion of the additive toolheads 111 are configured to deposit a single material type. Optional tool changer system 117 is used to move each of the additive 111 and/or subtractive toolheads 113 between storage locations and one or more operable positions. In an alternate embodiment, a material change system may be utilized to switch materials deposited by one or more of the additive toolheads 111.

System 100 also includes M subtractive toolheads 113, where M is one or more. Each of the subtractive toolheads is capable of removing structural or support material in a spatially-localized region, including a finite thickness in the Z dimension, referred to herein as the subtractive layer thickness.

Embodiments of the subtractive toolheads 113 include at least a laser subtractive toolhead 113a for removing material using laser vaporization, ablation, melting, reactive cutting, decomposition, or any other laser machining process known in the art. The laser subtractive system may utilize a gas laser, such as carbon dioxide laser; fiber laser; diode laser; or any other type of laser system source known in the art. Laser wavelengths may be selected to optimize energy absorption of material, and laser subtractive toolheads may include multiple lasers at different wavelengths to operate sequentially or simultaneously on homogeneous and composite materials. The laser system may be adapted for pulsed or continuous operation, including ultra-short pulsed lasers such as nanosecond, picosecond and femtosecond pulse lasers.

Embodiments of the laser subtractive toolhead 113a may include a beam steering system for directing the laser to a spatially-localized region. Beam steering system may include one or two axis galvometer scanner systems, a flying optics head coupled with a gantry or other motion system, acousto-optic modulators, or any other combination of lenses, mirrors, other optical elements, and actuators. Alternate embodiments of the invention may include one- or two-dimensional arrays of laser emitters instead of or in addition to the beam steering system.

Additionally, embodiments of the laser subtractive toolhead 113a may include an optical system for steering and focusing the laser beam on to an imaging plane. Embodiments of the optical system may include F-theta optics that produce a substantially linear beam displacement at the imaging plane as a function of the incoming beam angle. Dimensionally accurate laser machining may be achieved with the assistance of this linear relationship alone.

Further embodiments of the laser subtractive toolhead 113a may include telecentric scanning optics, which cause the laser beam to intersect the imaging plane at a constant angle (typically 90 degrees) regardless of the displacement from the lens axis. This ensures a consistent laser beam spot shape and size in the imaging plane regardless of displacement. Dimensionally accurate laser machining may be achieved with the assistance of this consistent beam angle, spot shape, and spot size.

Still further embodiments of the laser optical system may include a dynamically controlled focal optics for varying the optical system focal length as a function of displacement and/or desired machining depth at the imaging plane. Additionally, subtractive laser toolhead 113a may be coupled with an additional z-axis linear actuator to provide for fine adjustments to the imaging plane location.

Embodiments of the optical system may include any of the above features alone or in combination with other features, and optical systems may include lenses, mirrors, prisms, apertures, diffractive optical elements, and any other type of optical element known in the art.

In addition to the subtractive laser toolhead 113a, embodiments of system 100 may optionally include one or more additional subtractive toolheads, such as subtractive toolhead 113b. These additional subtractive toolheads may also utilize laser machining or any other subtractive manufacturing tool known in the art, including cutting tools, milling spindles, abrasive grinders, electric discharge machining, waterjet cutting, and plasma cutting.

As described below, embodiments of the invention fabricate parts in layers with additive and subtractive processing operations. To ensure dimensional accuracy in the z dimension, embodiments of the invention utilize a facing toolhead 115 to face machine or plane recently deposited additive layers to a dimensionally controlled thickness, z height, and surface finish. In other embodiments, one or more of the additive deposition toolheads 111 include a forming or smoothing tool to impart a dimensionally controlled z-height to recently deposited material while it is still in a plastic or semi-solid state. In still further embodiments, one or more of the subtractive toolheads 113 may perform face machining or planning as part of the set of subtractive processing operations.

System 100 includes a bed or build platform 103 for supporting parts under construction. Bed 103 may include materials and features for promoting adhesion of the part to the bed during fabrication and facilitating part release upon part completion.

In an embodiment, bed 103 is coupled with X 107, Y 109, and Z 105 linear motion axes. These motion axes move the bed 103 with respect to additive deposition toolheads 111 to selectively deposit spatially-varying patterns of one or more materials in layers on the bed 103 or previously-deposited layers of similar or different material. In alternate embodiments of the invention, one or more of the motion axes may be coupled with at least one of the additive toolheads 111, such that the toolhead moves with respect to bed 103 on these one or more axes. In still further embodiments of the invention, the cartesian arrangement of linear motion axes 107, 109, and 105 may be replaced with other arrangements of linear and/or rotary motion axes to impart relative motion between the bed 103 or toolheads 111, 113, and 115. Examples of alternative axes arrangements include parallel manipulators such as delta and Stewart platforms and CoreXY and H-Bot Cartesian gantries; serial manipulators such as SCARA and other multi-axis robot arms; and polar gantries.

Embodiments of system 100 may also include environmental systems for controlling the environment in the build volume. Environmental systems may include thermal systems for controlling the ambient temperature; atmospheric systems for maintaining vacuum or an inert gas atmosphere; ventilation and filtration for removing fumes or other byproducts of additive and/or subtractive processing; ambient or directed cooling, including liquid, gas, forced-air, or vapor cooling, for assisting additive and/or subtractive processing; and localized vacuum or compressed air or liquid to remove swarf, chips, dust, or other waste from subtractive processing.

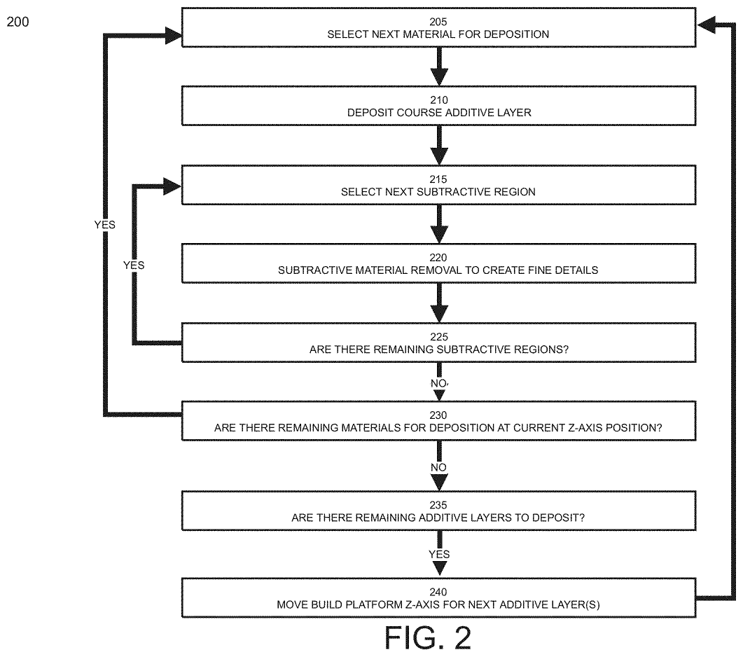

FIG. 2 illustrates a general method of operation 200 for a hybrid additive and subtractive manufacturing system according to an embodiment of the invention. The general method of operation 200 includes depositing an additive layer at coarse resolution to maximize volumetric throughout and then forming one or more subtractive layers from each additive layer to maximize surface detail and dimensional accuracy.

Method 200 begins with step 205 selecting the next material for deposition. Embodiments of the invention may utilize a preferred order of material deposition. For example, the first material selected for each additive layer may be a support material, which is used to support structural materials and, as described below, define undercut geometry. In a further embodiment, after support material deposition, materials are deposited in order of decreasing deposition temperature, so that each material does not substantially alter the geometry or characteristics of previously deposited materials.

Step 210 deposits a coarse additive layer using the selected material. In an embodiment, the additive layer thickness and minimum feature size are selected to maximize the volumetric throughput of the deposition. For example, a typical additive layer thickness may be 1 mm or more, and have a minimum feature size of 1 mm or more. In contrast, typical fused filament fabrication systems often use a layer thickness of 0.1 mm and a minimum feature size of 0.5 mm to provide minimally acceptable amounts of detail.

Step 215 selects the next subtractive region to be machined from the current additive layer. In an embodiment, each subtractive region is a substantially planar region parallel to and residing at least partially within the current additive layer. In alternate embodiments, subtractive regions may not be planar and/or parallel with the additive layer. In an embodiment, subtractive regions are machined in decreasing Z order.

Step 220 performs subtractive material removal to create fine surface details in the selected subtractive region. In an embodiment, the subtractive region includes planar regions with a layer thickness and minimum feature size selected to maximize the surface detail and dimensional accuracy of the part.

Step 225 determines if there are any remaining subtractive regions to be machined from the current additive layer. If so, method 200 proceeds to step 215 to select the next subtractive regions. Otherwise, step 230 determines if there are any remaining materials to be deposited in this additive layer. If so, then method 200 proceeds to step 205 to select the next material for additive deposition.

If all of the materials specified for the additive layer have been deposited and all of the subtractive layers have been machined from their respective materials, then step 235 determines if there any additive layers remaining for the part. If not, then method 200 ends. Otherwise, step 240 moves the bed z axis to the next position and method 200 proceeds to step 205 to fabricate the next additive layer.

Although method 200 shows the fabrication of additive and subtractive layers sequentially for the sake of exposition, embodiments of the invention may perform these operations in parallel to the maximum extent possible to optimize manufacturing throughput. In these embodiments, step 220 is performed in parallel with the additive deposition of step 210. For example, one or more subtractive layers may be machined from recently deposited material on one part of the part surface while the additive deposition toolhead is depositing the same or different material on a different portion of the part surface or the part interior. In this embodiment, the additive layer thickness, additive deposition minimum feature size, subtractive layer thickness, and minimum feature size may be selected so that the cumulative duration of subtractive operations is less than or equal to the duration of the additive operations for the selected additive layer for parts with typical geometric complexity.

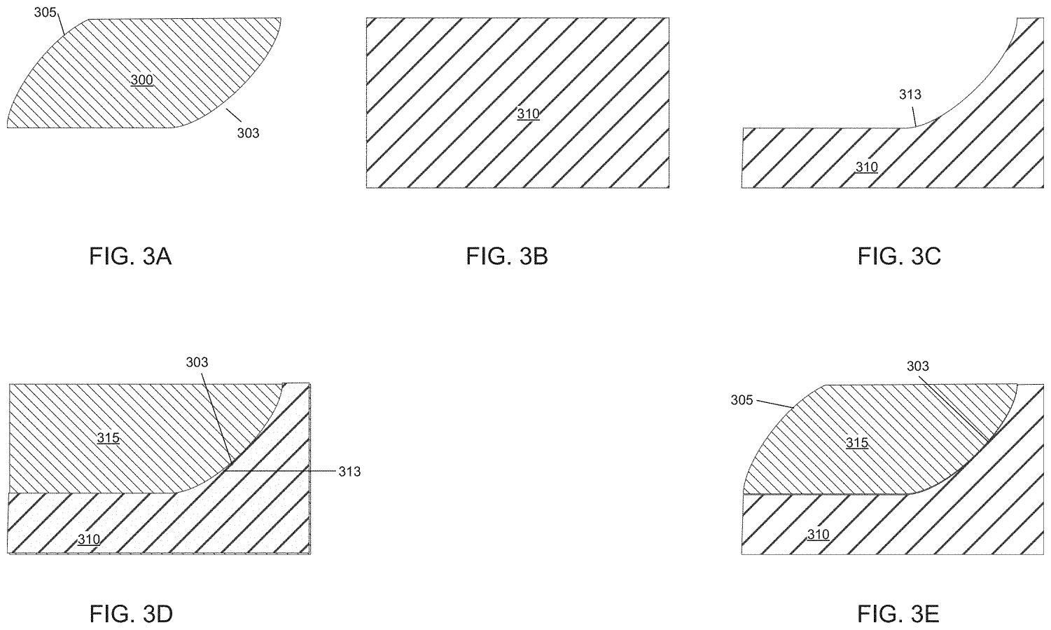

FIGS. 3A-3E illustrate the formation of part geometry through additive and subtractive operations according to an embodiment of the invention. FIG. 3A shows a cross-section view of an example desired part geometry 300 including an undercut region 303 and an “overcut” region 305.

FIG. 3B shows the deposition of an additive layer of support material 310, the first step for manufacturing this part geometry 300.

FIG. 3C illustrates the support material 310 following the machining of one or more subtractive layers in the support material, including the formation of support recess 313. Support recess 313 includes geometry complementary to the desired undercut region 303.

FIG. 3D illustrates the next step of manufacturing part geometry 300 with the deposition of part structural material 315. Due to the previously formed recess 313 in support material 310, structural material 315 includes the undercut region 303 desired in the part geometry 300. Embodiments of the invention may modulate the amount of additive material deposition based on the profile of the support or other structural materials previously deposited in the same region.

FIG. 3E illustrates the structural material 315 following a second set of subtractive operations to form overcut region 305. At this point, the structural material 315 matches the shape of desired part geometry 300, including undercut 303 and overcut 305 regions. Support material 310 can be removed following fabrication of the part.

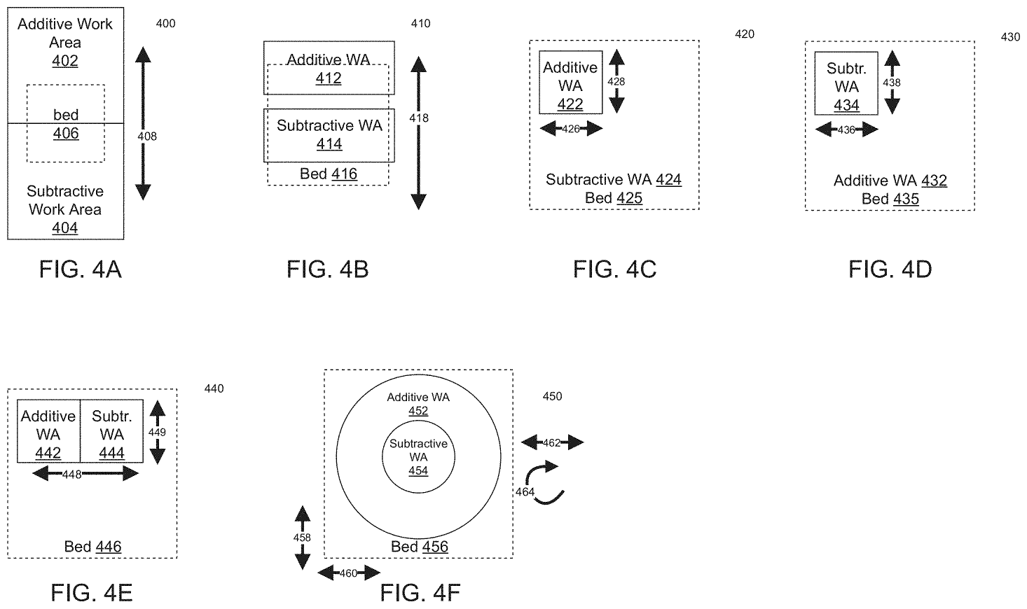

Embodiments of the invention may arrange the additive and subtractive work areas and bed in a variety of ways to allow for parallel operation of additive and subtractive operations and maximizing throughput. FIGS. 4A-4F illustrate several example manufacturing system architectures according to embodiments of the invention.

FIG. 4A illustrates architecture 400 including an additive work area 402 and an adjacent subtractive work area 404. The bed 406 moves on axis 408 between these work areas 402 and 404 to perform additive and subtractive operations sequentially.

FIG. 4B illustrates architecture 410 including an additive work area 412 and an adjacent subtractive work area 414. Each of these work areas 412 and 414 cover a portion of the bed 416. The bed 416 moves on axis 418 so that each work area can access any portion of the bed 416. In this example, additive and subtractive operations on different strips of the bed may be performed in parallel.

FIG. 4C illustrates architecture 420 including a small additive work area 422 overlapping with subtractive work area 424. In this example, subtractive work area 424 covers the entire bed 425. The additive work area 422 moves on axes 426 and 428 to access any portion of bed 425. Additive and subtractive operations may be performed in parallel in this architecture. In an embodiment, the system identifies areas of potential interference of additive work area 422 and its associated motion axes with the subtractive work area 424 as the additive work area 422 moves around the bed 425 and inhibits subtractive operations in these interference areas until the additive work area has moved to a different position.

FIG. 4D illustrates architecture 430 including a small subtractive work area 434 overlapping with additive work area 432. In this example, additive work area 432 covers the entire bed 435. The subtractive work area 434 moves on axes 436 and 438 to access any portion of bed 435. Additive and subtractive operations may be performed in parallel in this architecture. In an embodiment, the system identifies areas of potential interference of subtractive work area 434 and its associated motion axes with the additive work area 432 as the subtractive work area 434 moves around the bed 435 and inhibits additive operations in these interference areas until the subtractive work area 434 has moved to a different position.

FIG. 4E illustrates architecture 440 including small additive 442 and subtractive 444 work areas. Both the additive 442 and subtractive 444 work areas move as a unit on axes 448 and 450 to access any portion of bed 446. Additive and subtractive operations may be performed in parallel in this architecture. In an embodiment, the system prioritizes moving the additive work area 442 around the bed 446 to deposit additive layers, and opportunistically performs subtractive operations in the subtractive work area 444 as this work area overlaps part surface regions that require subtractive operations. Because additive operations often include tracing both the surface contours and interior of the part and subtractive operations are often much faster than additive operations, this prioritization will often be sufficient to perform all of the desired subtractive operations associated with a given additive layer. However, if there are subtractive operations still pending upon completion of an additive layer, an embodiment of the invention may suspend additive operations and move the additive 442 and subtractive 444 work areas to portions of the bed 446 where subtractive operations are still required to perform the remaining subtractive operations.

FIG. 4F illustrates an architecture 450 including independently moveable additive and subtractive toolheads. These toolheads operate within work areas 452 and 454, respectively, which move over bed 456. Embodiments of architecture 450 may be implemented using the combined polar/cartesian motion gantry described in U.S. Pat. No. 10,073,434, entitled “Manufacturing systems and methods with independent toolheads” and incorporated by reference herein, which allows for two independent toolheads to move over a work area without risk of collision. In these embodiments, the subtractive work area 454 moves along cartesian axes 458 and 460 and the additive work area 452 moves, relative to the subtractive work area 454, along polar axes 462 and 464 or, in alternate embodiments, vice-versa.

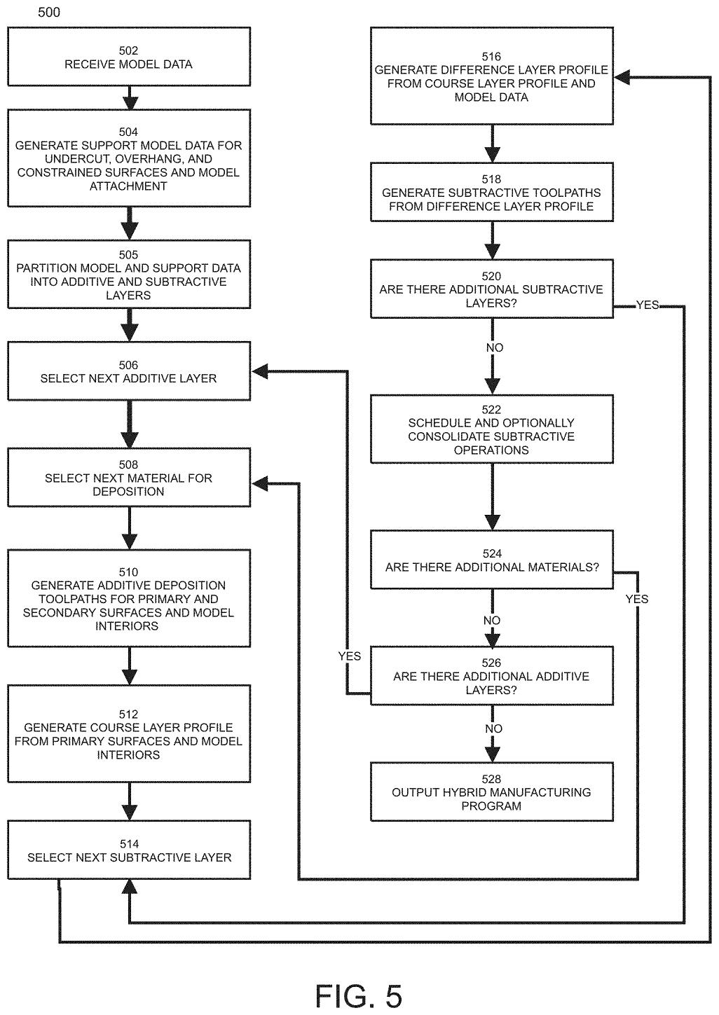

FIG. 5 illustrates an example method 500 for converting design data into a manufacturing program for a hybrid additive and subtractive manufacturing system according to an embodiment of the invention. Step 502 receives model data defining the part or parts to be manufactured. In an embodiment, the model data includes solid and/or surface geometry of the part or parts. In a further embodiment, the model data specifies the position of parts relative to the bed or each other, allowing the method 500 to produce batches of parts or assemblies of parts. In still a further embodiment, the model data includes material specifications for each part, indicating the material or materials that are to be used for each part.

In yet another embodiment, the model data includes manufacturing data such as specifications of dimensional tolerances, specifications of the number or thickness of subtractive layers, the type of additive and subtractive operations to be performed, and/or manufacturing parameters for these operations, such as a material deposition density, deposition temperature, and/or subtractive machining parameters. This manufacturing data may be applied to a batch, group, or assembly of parts, a single part, or a portion of a part. For example, an assembly may require high precision and small subtractive layer thickness for dimensionally critical portions such as bearings and mating surfaces and low precision and large subtractive layer thickness for less critical portions such as a mechanical housing.

Step 504 generates support model data for undercut, overhang, and constrained model surfaces. Undercut surfaces are model surfaces that are inaccessible to the subtractive toolheads after the part has been fabricated. Overhang surfaces are model surfaces that need to be supported from below. Constrained model surfaces are model surfaces that need to supported from the side, such as materials with poor adhesion to support materials, other structural materials, or the bed. Support model data includes geometry extending from the undercut, overhang, and constrained surfaces to another portion of the same part, a different part, or the bed. Model attachment support is added to attach the bottom of the parts to the bed using structural or support material. Model attachment support provides a secure attachment of parts to the bed and/or constrains portions of the parts to minimize warping due to thermal changes. Surfaces, as used herein, refers to both exterior and interior surfaces of the part and support models.

Embodiments of the invention may utilize three-dimensional computer graphics model data in the form of surface data, such as polygon or triangle meshes, higher-order surfaces such as NURBS or subdivision surfaces; implicit surfaces and volumes; volumetric or solid models, such as voxel, octree, constructive solid geometry, boundary representation, or other solid geometry models; procedural models created by executing programs or procedures, such as shader programs; or any other type of geometry and material representations known in the art.

Step 505 partitions the model data and support model data into additive and subtractive layers according to the geometry, manufacturing and other model data. Embodiments of the invention define at least one and typically more than subtractive layer for each additive layer. In some embodiments, there is a whole number of subtractive layers for each additive layer. In other embodiments, a subtractive layer may straddle the boundary between two adjacent additive layers.

Step 506 selects the next additive layer for fabrication. In an embodiment, additive layers are selected in ascending order based on the z distance of the additive layer from the bed.

Step 508 selects the next material for deposition in the selected additive layer and the geometry and manufacturing data associated with the selected material. In an embodiment, the support material is selected first. In a further embodiment, structural materials are selected after the first support material in order of descending deposition temperature. In still further embodiments, the material selection order may be determined at least in part by the physical, chemical, thermal, and processing compatibility between materials. In yet further embodiments, multiple support materials may be utilized based on the physical, chemical, thermal, and processing compatibility between the support material and one or more structural materials.

Step 510 generates additive deposition toolpaths for primary model surfaces, secondary model surfaces, and model interiors associated with the selected material. Primary model surfaces are regions of part model and support model surfaces that require subtractive processing to satisfy dimensional accuracy requirements. These include portions of the parts that have tight dimensional accuracy and/or surface finish requirements as well as portions of the support model surfaces in contact with dimensionally accurate portions of the part model surface. Secondary model surfaces are part model and support model surfaces that do not require subtractive processing. These include portions of the parts that do not have tight dimensional tolerances and portions of the support model surfaces not in contact with the part surfaces. Model interiors are the regions of the part or support model not including any interior or exterior surfaces.

In an embodiment, step 510 generates these additive deposition toolpaths by first creating one or more contours based on the intersection of each exterior and interior surface with a plane representing the selected additive layer and then tracing these contours to determine additive deposition toolpaths. Model interiors are portions of the part models and support models that do not include any interior or exterior surface regions. In an embodiment, additive toolpaths for model interiors are generated by applying an infill pattern to the regions bounded by exterior and optionally interior contours. In a further embodiment, additive toolpaths for model interiors may be generated by determining an optimal space-filling path for each region bounded by exterior and optionally interior contours.

In some embodiments, additive deposition toolpaths forming coarse exterior and interior surface contours are preferentially performed before additive deposition toolpaths filling model interiors. This maximizes the available time for performing subtractive operations on model surfaces in parallel with additive operations.

Step 512 generates a course layer profile from the primary surfaces and model interiors. In an embodiment, step 512 sweeps a shape representing the region of local additive deposition along the additive toolpaths associated with the primary surfaces and model interiors. In another embodiment, this operation may be performed by determining the Minkowski sum of the deposition region shape and the additive toolpaths. In still another embodiment, a dilation or path offset operation may be applied to a plot of the additive toolpaths. In yet another embodiment, a dilation or path offset operation is performed directly from the geometric data resulting from the intersection of exterior and interior contours with a plane representing the selected additive layer, rather than the additive deposition toolpaths.

Regardless of the embodiment, the result is a two-dimensional or three-dimensional vector, raster, or volumetric geometric representation of the shape of the material in the selective additive layer following the additive deposition and prior to any subtractive operations. Due to variability in the additive deposition process, particularly when depositing liquid, semi-solid, plastic, or powder materials, the coarse layer profile may be generated marginally larger than anticipated from the actual additive deposition process to account for this variability and ensure that any subtractive operations remove all excess material.

Step 514 selects the next subtractive layer associated with the current additive layer. In an embodiment, subtractive layers are selected in descending order based on distance from the bed.

Step 516 generates a difference layer profile for the selected subtractive layer. The difference layer profile specifies the geometry of additively deposited material that needs to be removed using subtractive operations to produce the desired parts' shapes in the selected subtractive layer. In an embodiment, step 516 determines a fine layer profile, representing the primary, secondary, and model interior geometry of the model and support model data that intersects a plane associated with the selected subtractive layer. In this embodiment of step 516, the fine layer profile is subtracted from the coarse layer profile to generate the difference layer profile for the selected subtractive layer. Embodiments of the invention may utilize analytical or numerical techniques for generating the difference layer profile.

Step 518 generates subtractive toolpaths based on the difference layer profile for the selected subtractive layer. In an embodiment, step 518 generates these subtractive toolpaths by tracing one or more interior and optionally exterior contours of each region in the difference layer profile. In further embodiments, step 518 generates subtractive toolpaths for the interiors of each region in the difference layer profile by applying an infill pattern or determining an optimal space-filling path.

As discussed in detail below, step 518 may be deferred until difference layer profiles for two or more adjacent subtractive layers are generated and a subtractive operation consolidation step has been completed.

Step 520 determines if there are additional subtractive layers associated with the current additive layer and yet to be processed. If so, method 500 returns to step 514. Otherwise, method 500 proceeds to step 522.

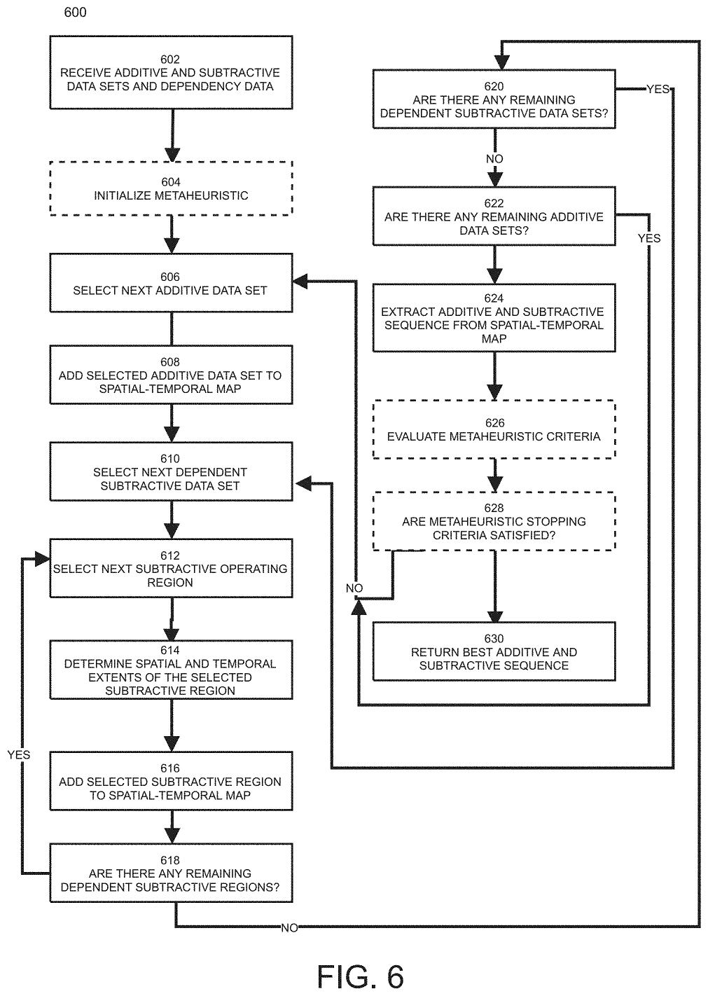

After all of the subtractive layers associated with a selected additive layer have been processed, step 522 schedules the subtractive operations for execution, preferably in parallel with the additive deposition operations associated with the selected additive layer. In general, a subtractive operation in a given region and associated with a given material can be performed as soon as the additive deposition operation depositing this material in the same region is complete and the subtractive toolhead associated with this subtractive operation can access this region without interfering with the additive toolhead. Method 600 of FIG. 6, discussed below, illustrates a method of scheduling subtractive operations in parallel and/or series with additive operations according to an embodiment of the invention. Embodiments of step 522 and method 600 may schedule subtractive operations by analyzing and manipulating subtractive toolpath operations or alternatively by analyzing portions of the additive and difference layer profiles, scheduling portions of the difference layer profiles to be performed in parallel or sequence with the additive operations, and then generating subtractive toolpaths from the scheduled portions of the difference layer profiles.

In an embodiment, prior to scheduling subtractive operations, an embodiment of step 522 optionally consolidates subtractive operations in adjacent subtractive layers and overlapping in x and y dimensions. In general, subtractive operations in two or more adjacent layers that also overlap in the x and y dimensions may optionally be replaced with a single subtractive operation that removes material from the same x-y region in multiple subtractive layers simultaneously. For example, if a first laser machining subtractive operation needs to remove material from region (2<=x<=4; 1<=y<=2; 1.9<z<=2.0) and a second laser machining subtractive operation needs to remove material from region (2<=x<=4; 1<=y<=2; 1.8<z<=1.9), these two subtractive operations may, depending on the capabilities of the subtractive toolhead and limits of the selected material, be replaced with a single subtractive operation removing material from region (2<=x<=4; 1<=y<=2; 1.8<z<=2.0).

In one implementation of this embodiment, step 522 compares subtractive toolpath operations in adjacent subtractive layers to identify operations that can be consolidated. In another embodiment, step 522 performs geometric intersection operations between difference layer profiles of two or more adjacent subtractive layers. The results of these intersection operations, if any, define regions where subtractive operations may remove material from two or more adjacent subtractive layers simultaneously. These intersecting regions can then be subtracted from the difference layer profiles to identify remaining portions of each difference layer that require separate subtractive operations.

In another implementation of this embodiment, step 522 starts with the subtractive layer closest to the bed and associated with the current additive layer. The geometry of this layer defines subtractive operations that can be performed on this layer and also all of the other subtractive layers above it that are associated with the same additive layer. Step 522 then subtracts the geometry of this layer from each of the subtractive layers above it that are associated with the same additive layer. This process is then repeated with the remaining subtractive layers in order of increasing distance from the bed to define subtractive operations spanning each subtractive layer and the subtractive layers above it.

In these implementations, subtractive toolpaths are then generated following this geometric consolidation process.

Step 524 determines if there are any additional materials remaining to be processed in the selected additive layer. If so, method 500 proceeds to step 508. Otherwise, method 500 proceeds to step 526. Step 526 determines if there are any additional additive layers to be fabricated. If so, method 500 proceeds to step 506. Otherwise, step 528 outputs a hybrid manufacturing program.

In further embodiments of method 500, part features thinner than the additive layer thickness may be fabricated by repeating steps 506-524 two or more times for each additive layer.

FIG. 6 illustrates an example method 600 for coordinating dependencies between additive and subtractive manufacturing processes according to embodiments of the invention. Step 602 receives additive and subtractive data sets and dependency data. Additive and subtractive data sets include data for at least one additive layer and its associated one or more subtractive layers. Embodiments of additive data sets include additive deposition toolpaths or alternatively geometric data defining regions of an additive layer receiving material deposition. Similarly, embodiments of subtractive data sets include subtractive deposition toolpaths or alternatively geometric data defining regions of one or more subtractive layers where material will be removed.

In addition to additive and subtractive data sets, embodiments of step 602 include dependency data indicating a preferred and/or required order of additive and subtractive operations.

In embodiments of the invention, determining a globally optimal scheduling of additive and subtractive operations in parallel may be considered an NP-hard combinatorial optimization problem, similar to the travelling salesperson optimization problem. In these embodiments, any of the many heuristics and algorithms known in the art may be applied to find a globally or locally optimal scheduling. Fortunately, as additive deposition operations are often the bottleneck in performance, any scheduling of subtractive operations that can be completed prior to or at the completion of additive deposition operation may be considered sufficiently optimal; therefore, finding a globally optimal scheduling is often unnecessary.

In one embodiment of the invention, method 600 optionally uses metaheuristic techniques to generate multiple alternative subtractive operation schedules to find a schedule that is at least locally optimal. Example metaheuristics include, but are not limited to, hill climbing, simulated annealing, tabu search, and genetic optimization. If method 600 is using a metaheuristic, then optional step 604 initializes the metaheuristic data.

Step 606 selects the next additive data set. In an embodiment, each additive data set includes the additive deposition toolpaths or equivalent geometric data associated with a specific material and/or material deposition process utilized within the additive layer. Step 606 selects additive data sets in an order determined by the dependency data received in step 602, such as a material deposition or processing sequence.

Embodiments of method 600 utilize a spatial-temporal map to schedule subtractive and additive operations in parallel. The spatial-temporal map partitions the space corresponding with an additive and associated subtractive layers into a number of discrete spatial regions. For each spatial region, the spatial-temporal map is adapted to store absolute or relative time values indicating when each additive deposition operation in this region is complete; time values when each subtractive operation in this region is initiated and completed; optionally zero, one, or more time intervals when the region is partially or fully contained in the subtractive work area (or conversely outside the subtractive work area); and optionally zero, one, or more time intervals where an additive deposition toolhead, motion gantry, additive material supply conveyance, or other hardware impedes access to the region for a subtractive toolhead (or conversely the subtractive toolhead is not impeded from accessing the region). Additionally, the spatial-temporal map may include a master subtractive schedule for tracking time intervals across all map regions in which the subtractive toolhead is being utilized by previously scheduled subtractive operations.

Embodiments of the spatial-temporal map may partition the space corresponding with the additive and associated subtractive layers into fixed regions, such as a regular two- or three-dimensional grid, or variable size regions, for example using a quadtree or octree. Embodiments of the spatial-temporal map may use a partitioning that is constant across all additive layers or that varies based on the geometry within each additive layer. In an further embodiment, the spatial-temporal map may be dynamically partitioned based on the spatial extents, such as a bounding box or convex hull, of the additive and/or subtractive operations, for example using a hierarchical spatial partitioning structure such as a quadtree.

Step 608 adds the selected additive data set to a spatial-temporal map. In an embodiment, step 608 updates the spatial-temporal map with the time values that the additive deposition operations in the additive data set and associated with exterior and/or interior surface contours will be completed. These values determine the potential earliest time that subtractive operations associated with these surface contours may be initiated.

In an embodiment, step 608 selects each additive operation in the selected additive data set. For each additive operation, step 608 identifies one or more regions in the spatial-temporal map that overlap the selected additive operation and determines a time value indicating when the selective additive operation is complete. Step 608 then adds the selected additive operation and its time value to the identified spatial-temporal map regions. If the selected additive operation is not associated with an interior or exterior surface contour, then an embodiment of step 608 may skip adding this additive operation to the spatial-temporal map.

If the subtractive work area changes based on the position of the additive deposition toolhead, such as in motion architectures 410, 440, and 450 discussed above, then a further embodiment of step 608 may optionally update the spatial-temporal map with the zero, one, or more time intervals when the region is partially or fully contained in the subtractive work area. If the additive deposition toolhead is capable of impeding the subtractive toolhead's access to the region, such as in motion architecture 420 discussed above, then step 608 may optionally update the spatial-temporal map with the optionally zero, one, or more time intervals where this access is impeded. These two types of optional additional time intervals further limit the times that subtractive operations may be scheduled for this region. In these embodiments, step 608 may consider additive operations associated with both surface contours and model interiors to determine time intervals when spatial-temporal map regions are accessible to the subtractive toolhead.

Step 610 selects the next dependent subtractive data set. Each subtractive data set includes subtractive operations or equivalent geometric data associated with one subtractive layer or a set of two or more adjacent subtractive layers processed simultaneously. In an embodiment, subtractive data sets are selected based at least in part on the distance of an associated subtractive layer from the bed, similar to the order of selecting subtractive layers discussed in method 500.

Step 612 selects the next subtractive operation region from the selected subtractive data set. A subtractive operation region is one or more related subtractive operations or equivalent geometric data specifying a region affected by a subtractive operation.

Step 614 determines spatial and temporal extents of the selected subtractive operation region. The spatial extents represent the geometric region of the subtractive layer affected by the subtractive operation. Embodiments of step 614 may utilize a bounding polygon, such as a bounding box or convex hull as a conservative approximation of the spatial extents instead of an exact geometric representation of this region. The temporal extents of the selected subtractive operation region represent the time duration required to perform the associated subtractive operations in the subtractive operation region. The temporal extents may optionally include additional time for the subtractive toolhead to move to the subtractive operation region and/or activating the subtractive toolhead and initiating a subtractive operation.

Step 616 adds the selected subtractive operation region to the spatial-temporal map. In an embodiment, step 616 identifies one or more regions of the spatial-temporal map overlapping the spatial extents of the selected subtractive operation. For each identified region of the spatial-temporal map, step 616 schedules a subtractive operation for the selected subtractive operation based on the available time intervals in which the spatial-temporal region is within the subtractive work area and is accessible to the subtractive toolhead. Step 616 stores the selected subtractive operation region and time values representing the scheduled operation's start and end times in the spatial-temporal map region.

Embodiments of step 616 may use any scheduling technique or heuristic known in the art to optimize scheduling of subtractive operations within the available time intervals of a spatial-temporal regions, including greedy algorithms. In further embodiments of step 616, the greedy algorithm may include scheduling subtractive operations in the first available time interval or the smallest available time interval of the spatial-temporal region. Regardless of the heuristics or scheduling techniques utilized, step 616 updates the spatial-temporal map based on the scheduled subtractive operations. This may be done by updating the time intervals of each identified spatial-temporal region and/or updating the master subtractive schedule with the newly scheduled subtractive operations.

If there are no available time intervals for a selected subtractive operation region, then an embodiment of the invention schedules the selected subtractive operation region to a time period after completion of the additive data set. In this embodiment, additional operations may be added to move the subtractive work area to include the necessary spatial-temporal region or regions and optionally move the additive toolhead away from the subtractive work area to allow for subtractive toolhead access.

Step 618 determines if there are any remaining dependent subtractive operations to be processed. If so, method 600 returns to step 612. Otherwise, method 600 proceeds to step 620. Step 620 determines if there are any remaining subtractive data sets to be processed. If so, then method 600 returns to step 610. Otherwise, method 600 proceeds to step 622 to determine if there are any remaining additive data sets to processed. If so, then method 600 returns to step 606. Otherwise, method 600 proceeds to step 624.

Step 624 extracts a sequence of additive and subtractive operations from the spatial-temporal map. In an embodiment, step 624 selects each of the regions of the spatial-temporal map and adds the additive and subtractive operations assigned to this region to a combined operations sequence, ordered according to the time values associated with each operation.

Optional step 626 evaluates metaheuristic criteria to determine if a satisfactory scheduling of additive and subtractive operations has been determined. Embodiments of step 626 may evaluate the fitness of the combined additive and subtractive sequence from step 624, such as whether the subtractive operations are completed prior to the completion of the additive operations, compare this sequence with one or more alternative combined sequences of additive and subtractive operations from previous iterations of steps 606 to 624, and evaluate metaheuristic parameters such as the number of iterations of steps 606-624 and the rate of improvement in results after multiple iterations.

Step 628 determines if the metaheuristic criteria for stopping are satisfied. If not, then method 600 proceeds to step 606 to determine an alternative scheduling of additive and subtractive operations. In an embodiment, one or more scheduling parameters and/or the sequence of subtractive operations is modified, and steps 606 to 624 are modified to produce a different scheduling of additive and subtractive operations in this iteration.

If the metaheuristic criteria are satisfied, then step 630 outputs a combined sequence of additive and subtractive operations representing the best-known scheduling. It should be noted that this combined sequence of additive and subtractive operations may not necessarily be the most recently determined sequence.

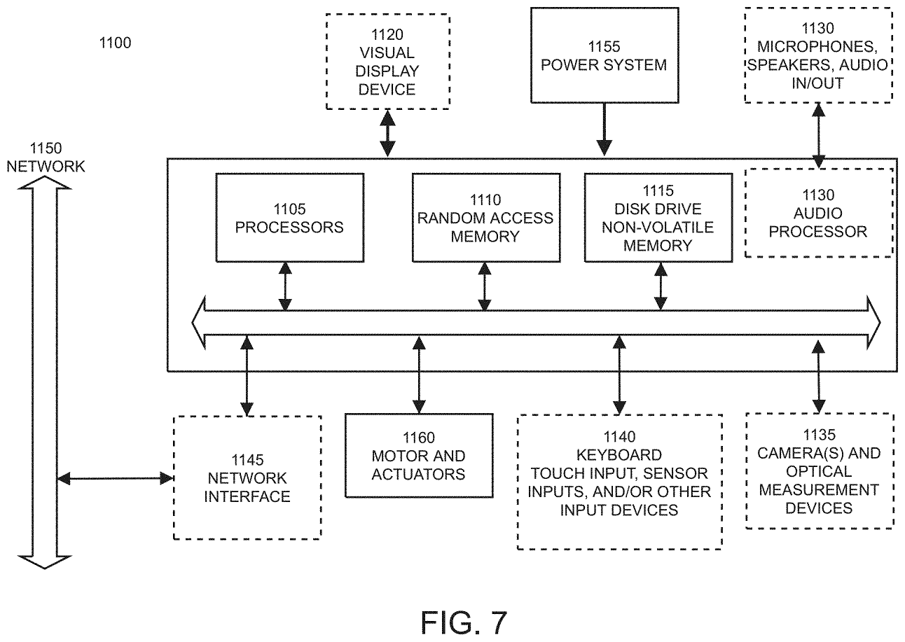

FIG. 7 illustrates a computer system suitable for controlling an automated manufacturing system including two independently and simultaneously operating toolheads according an embodiment of the invention. The computer system 1100 includes one or more general purpose or specialized processors 1105, which can include microprocessors, microcontrollers, system on a chip (SoC) devices, digital signal processors, graphics processing units (GPUs), ASICs, FPGAs, and other information processing devices. The computer system 1100 also includes random access memory 1110 and non-volatile memory 1115, such as a magnetic or optical disk drive and/or flash memory device.

The computer system 1100 may optionally include one or more visual display devices 1120. The computer system 1100 may also optionally include an audio processor 1125 for generating and receiving sound via speakers, microphone, or other audio inputs and outputs 1130; and optional sensors and input devices 1140 such as keyboards; scroll wheels; buttons; keypads; touch pads, touch screens, and other touch sensors; joysticks and direction pads; motion sensors, such as accelerometers and gyroscopes; global positioning system (GPS) and other location determining sensors; temperature sensors; mechanical, optical, magnetic or other types of position or angle detectors and/or limit switches for detecting the current positions of the various components of the above-described systems; voltage, current, resistance, capacitance, inductance, continuity, or any other type of sensor for measuring electrical characteristics of the various components of the above-described systems; force, acceleration, stress or strain, and/or tension sensors; and/or any other type of input device known in the art. Computer system 1100 may optionally include one or more cameras or other optical measurement devices 1135 for capturing still images and/or video.

The computer system 1100 may also include one or more modems and/or wired or wireless network interfaces 1145 (such as the 802.11 family of network standards) for communicating data via local-area networks 1150; wide-area networks such as the Internet; CDMA, GSM, or other cellular data networks of any generation or protocol; industrial networks; or any other standard or proprietary networks. The computer system 1100 can also include a peripheral and/or data transfer interface, such as wired or wireless USB, IEEE 1394 (Firewire), Bluetooth, or other wired or wireless data transfer interfaces.

The computer system 1100 can include a power system 1155 for obtaining electrical power from an external source, such as AC line current or DC power tailored to the computer system 1100 via an external power supply, as well as one or more rechargeable or one-time use batteries, fuel cells, or any other electrical energy generation device. Additionally, power system 1155 may provide energy in the form of compressed gas, vacuum, and/or hydraulic pressure to power various actuators and components of embodiments of the invention.

Computer system 1100 may be implemented in a variety of different form factors, including desktop and laptop configurations as well as embedded and headless forms.

Embodiments of the invention use a variety of linear and rotary motors and actuators, such as brushed or brushless DC motors; AC synchronous and induction motors; stepper motors; servomotors; solenoids; leadscrews, ballscrews, linear motors, or other mechanical devices for creating linear motion; and/or pneumatic and hydraulic actuators. In an embodiment, computer system 1100 include motor and actuator controls 1060 for providing power and control signals to these motors and actuators.

Further embodiments can be envisioned to one of ordinary skill in the art. In other embodiments, combinations or sub-combinations of the above disclosed invention can be advantageously made. The block diagrams of the architecture and flow charts are grouped for ease of understanding. However, it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

1.-18. (canceled)

19. A method of coordinating additive and subtractive operations in a hybrid manufacturing system, the method comprising:
receiving an additive data set specifying additive regions where at least one material should be additively deposited by an additive toolhead;
receiving a subtractive data set specifying subtractive regions where at least a portion of the additively deposited material should be subtractively removed by a subtractive toolhead;
adding the additive data set to a spatial-temporal map, wherein the spatial-temporal map includes map regions, wherein at least some of the map regions include additive time intervals indicating when additive material deposition within the region is complete;
identifying a subset of the map regions overlapping in space the subtractive regions of the subtractive data set;
scheduling the subtractive regions based at least in part on the additive time intervals of their respective map regions; and
generating a combined sequence of additive and subtractive operations from the spatial-temporal map.

20. The method of claim 19, further comprising outputting a hybrid numerical control program specifying the combined sequence of additive and subtractive operations.

21. The method of claim 19, wherein scheduling the subtractive regions comprises, for each of the subtractive regions, assigning to the subtractive region a subtractive operation time interval after the additive time interval of the overlapping map region.

22. The method of claim 21, wherein at least some of the map regions include accessibility time intervals when the map regions are accessible to the subtractive toolhead, wherein each subtractive operation time interval is within the accessibility time interval of its overlapping map region.

23. The method of claim 22, wherein the accessibility time intervals are based at least in part on positions of the additive toolhead relative to the map regions during the accessibility time intervals.

24. The method of claim 21, wherein the subtractive operation time intervals of at least a first portion of the subtractive regions overlap in time with the additive time intervals of a second portion of the map regions, where the first portion of the subtractive regions and the second portion of the map regions do not overlap in space.

25. The method of claim 19, wherein the additive data set includes model data and support model data.

26. The method of claim 19, wherein the additive data set is partitioned into additive layers, the subtractive data set is partitioned into subtractive layers, and the spatial-temporal map encloses at least a portion of the additive and subtractive layers.

27. The method of claim 26, wherein the subtractive data set is derived from a difference layer profile, wherein the difference layer profile is generated by subtracting model data and support data from a coarse layer profile.

28. The method of claim 26, wherein at least one additive layer encloses two or more subtractive layers.

29. The method of claim 28, wherein scheduling the subtractive regions includes consolidating at least two subtractive regions representing adjacent subtractive layers at different z dimensions and at least partially overlapping in x and y dimensions into a single subtractive region.

30. The method of claim 19, wherein the spatial-temporal map includes a partitioning of space into fixed size regions.

31. The method of claim 19, wherein the spatial-temporal map includes a partitioning of space into variable size regions dependent on the geometry within the additive and subtractive data sets.

32. The method of claim 31, wherein the spatial-temporal map includes a hierarchical partitioning of space.

33. The method of claim 32, where the spatial-temporal map includes a quadtree.

34. The method of claim 32, where the spatial-temporal map includes an octree.

35. The method of claim 19, wherein scheduling the subtractive regions comprises applying a metaheuristic to generate and evaluate at least two alternative subtractive operation schedules and selecting one of the subtractive operation schedules as a locally optimal schedule.

36. The method of claim 19, wherein the additive deposition toolhead includes at least one extrusion tool for depositing at least one material and the subtractive toolhead includes a laser machining tool.
